(19) United States
(12) Patent Application Publication
(10) Pub. No.: US 2023/0127785 A1
(43) Pub. Date: Apr. 27, 2023

(54) MULTILAYER COLORED INTERMEDIATE LAYER HAVING A WEDGE-SHAPED CROSS-SECTION

(71) Applicant: SAINT-GOBAIN GLASS FRANCE, COURBEVOIE (FR)

(72) Inventors: Andrea WILLMS, AACHEN (DE); Stephan GIER, BOUS (DE)

(21) Appl. No.: 17/801,666

(22) PCT Filed: Mar. 25, 2021
(86) PCT No.: PCT/EP2021/057676

§ 371 Date: Aug. 23, 2022

(30) Foreign Application Priority Data
Apr. 7, 2020 (EP) 20168475.0

(51) Int. Cl. B32B 17/10; B32B 3/26; B32B 33/00; B32B 37/22

(52) U.S. Cl. CPC B32B 17/10568; B32B 17/10651; B32B 3/263; B32B 17/10036; B32B 17/10633; B32B 17/10678; B32B 17/10788; B32B 17/1077; B32B 17/10935; B32B 33/00; B32B 37/223; B32B 2250/03; B32B 2250/40; B32B 2307/102; B32B 2307/4026; B32B 2315/085; B32B 2331/04; B32B 2375/00; B32B 2329/06; B32B 2457/20; B32B 2605/006

(57) ABSTRACT

A multilayer colored thermoplastic intermediate layer, includes a first thermoplastic layer with a wedge-shaped cross-section; and a second thermoplastic layer having a substantially constant thickness, wherein the first thermoplastic layer is colorless and the second thermoplastic layer is colored with a dye.

The invention relates to a multilayer colored intermediate layer with a wedge-shaped cross-section, a composite pane having such an intermediate layer, a method for producing the same, and use of the same.

Composite panes are currently used in many places, in particular in the vehicle sector. Here, the term “vehicle” includes, among other things, road vehicles, aircraft, watercraft, agricultural machinery, or even work equipment.

Composite panes are also used in other sectors. These include, for example, architectural glazings or information displays, e.g., in museums or as advertising displays.

A composite pane generally has two panes that are laminated onto an intermediate layer. The panes themselves can be curved and are usually of constant thickness. The intermediate layer usually comprises a thermoplastic material, preferably polyvinyl butyral (PVB), of a predefined thickness, e.g., 0.76 mm.

Since the composite panes are often inclined relative to a viewer, double images occur. These double images are caused by the fact that incident light usually does not pass completely through both panes, but, instead, at least part of the light is reflected and passes through the second pane only after that. These double images are, in particular, noticeable in the darkness, in particular with strongly radiating light sources such as, for instance, the headlights of an oncoming vehicle. These double images are extremely distracting and are a safety issue.

Often, composite panes are also used as a head-up display (HUD) for displaying information. In that case, an image is projected by means of a projection apparatus onto the composite glass panes to insert information into the field of vision of the viewer. In the vehicle sector, the projection apparatus is, for example, arranged on the dashboard such that the projected image is reflected on the nearest glass surface of the composite glass pane inclined in the direction of the viewer (cf., e.g., EP 0 420 228 B1 or DE 10 2012 211 729 A1). Here again, however, part of the light enters the composite glass panes and is then reflected, for example, on the outside boundary layer of the glass surface farther out from the point of view of the viewer and subsequently exits the composite glass pane with an offset. Here, as well, a similar effect occurs, the effect of ghost images relative to the image to be displayed.

A purely conventional compensation of ghost images results in the fact that an overcompensation for double images in transmittance is observed. This results in the fact that the respective viewer is confused or, in the worst case, receives misinformation. This problem can be solved by no longer arranging the surfaces of the panes parallel to one another, but, instead, at a fixed angle. This is accomplished, for example, in that the intermediate layer and/or at least one of the panes is wedge-shaped with a continuously linearly and/or nonlinearly increasing and/or decreasing thickness. In the vehicle sector, the thickness is typically varied such that the smallest thickness is provided at the lower end of the composite glass pane toward the engine compartment, whereas the thickness increases toward the roof.

Composite panes of this type with a wedge-shaped intermediate layer and the optical principles on which they are based are known per se and are described, for example, in the international patent applications WO 2015/086234 A1 and WO 2015/086233 A1 or the German published patent applications DE 196 11 483 A1 and DE 195 35 053 A1.

In modern means of transportation such as trains or motor vehicles, acoustic comfort is increasingly important. To improve the acoustically damping properties of a composite pane, a multilayer intermediate layer including an acoustically damping layer arranged between two layers is commonly laminated between the two panes.

WO 2018/081570 A1, US 2016/0341960 A1, and EP 2 017 237 A1 disclose wedge-shaped multilayer intermediate layers that include a layer of constant thickness and a layer with a wedge-shaped cross-section, wherein the layer of constant thickness includes an acoustically damping layer arranged between two protective layers.

In colored intermediate layers with a wedge-shaped cross-section, wherein the dye concentration in the intermediate layer is constant over theirwidth, height, and thickness, there is the problem that, due to the wedge-shaped cross-section, the light transmittance through the intermediate layer is not constant over its area, i.e., over the entire height and the entire width. Thus, the light transmittance through the intermediate layer is higher at the thinner end of the intermediate layer and the color is brighter than at the thicker end of the intermediate layer. With increasing thickness, the light transmittance through the intermediate layer decreases and the color darkens.

WO 2019/189741 A1 discloses a wedge-shaped multilayer intermediate layer comprising an infrared-reflecting layer, a first resin layer, and a second resin layer, wherein the first resin layer is arranged on a first surface side of the infrared-reflecting layer, the second resin layer is arranged on a second surface side opposite the first surface of the infrared-reflecting layer, and wherein at least one of the first resin layer and the second resin layer has a wedge angle of 0.1 mrad or more, and at least one of the first resin layer and the second resin layer contains a colorant.

The object of the present invention is to provide a multilayer colored intermediate layer having a wedge-shaped cross-section, with which the light transmittance is constant over its entire area, the color is substantially constant over its entire area, and/or which is easy to manufacture.

The object of the present invention is accomplished according to the invention by a multilayer colored thermoplastic intermediate layer in accordance with claim 1 and a method in accordance with claim 12 or 13. The invention also relates to a composite pane, a projection arrangement, and the use of the multilayer colored thermoplastic intermediate layer in accordance with the coordinate claims. Preferred embodiments emerge from the dependent claims.

The invention relates to a multilayer colored thermoplastic intermediate layer, at least comprising a first thermoplastic layer with a wedge-shaped cross-section and a second thermoplastic layer having a substantially constant thickness.

Due to the fact that the first thermoplastic layer has wedge-shaped cross-section and the second thermoplastic layer has a substantially constant thickness, the multilayer colored thermoplastic intermediate layer has a wedge-shaped cross-section. In other words, the thermoplastic intermediate layer has a thicker first end and a thinner second end. The increase in thickness from the second end to the first end can be continuously linear or non-linear.

According to the invention, the first thermoplastic layer is colorless and the second thermoplastic layer is colored with a dye.

The dye can, for example, be an ink or a color pigment. The advantage in particular, of organic inks compared to, in particular, inorganic pigments is that they are more readily distributable.

However, organic inks are not as stable as inorganic pigments and age more quickly. But inorganic pigments agglomerate more than organic inks. Suitable inks or color pigments for the respective applications are known to the person skilled in the art such that this is not discussed in detail in the following. The dye concentration in the second thermoplastic layer is constant over its entire width, height, and thickness.

The multilayer colored thermoplastic intermediate layer preferably has a wedge angle in the range from 0.1 mrad to 1.0 mrad, particularly preferably 0.3 mrad to 0.6 mrad, for example, 0.5 mrad.

The thickness of the multilayer colored thermoplastic intermediate layer at its thinner second end is preferably between 0.3 mm and 1.0 mm, particularly preferably between 0.6 mm and 0.9 mm, for example, 0.76 mm.

In the present application, the term “substantially constant thickness” of a layer means that the thickness of the layer is constant over the length and width, i.e., consequently, over the entire area of the layer, in the context of normal manufacturing tolerances. Preferably, this means that the thickness varies by not more than 3%, preferably by not more than 2%, particularly preferably by not more than 1%.

In one embodiment, the first thermoplastic layer contains at least polyvinyl butyral (PVB), ethylene vinyl acetate (EVA), polyurethane (PU), or mixtures or copolymers or derivatives thereof, preferably polyvinyl butyral (PVB), particularly preferably polyvinyl butyral (PVB) and plasticizer.

In one embodiment, the second thermoplastic layer contains a dye and at least polyvinyl butyral (PVB), ethylene vinyl acetate (EVA), polyurethane (PU), or mixtures or copolymers or derivatives thereof, preferably polyvinyl butyral (PVB), particularly preferably polyvinyl butyral (PVB) and plasticizer.

In one embodiment, the multilayer colored thermoplastic intermediate layer according to the invention additionally includes an acoustically damping layer having a substantially constant thickness, wherein the acoustically damping layer is arranged between the first thermoplastic layer and the second thermoplastic layer.

The additional acoustically damping layer can be colorless or colored with a dye.

As described above, the dye can be an ink or color pigments.

The invention thus also relates to a multilayer colored thermoplastic intermediate layer at least comprising, in this order, a colorless first thermoplastic layer with a wedge-shaped cross-section, an acoustically damping layer having a substantially constant thickness, and a dye-colored second thermoplastic layer with substantially constant thickness, wherein the acoustically damping layer is colorless or colored with a dye.

The acoustically damping layer is preferably thinner than 300 μm (microns). The thickness of the acoustically damping layer is in particular 70 μm to 130 μm, for example, 100 μm.

The acoustically damping layer can contain at least polyvinyl butyral (PVB), ethylene vinyl acetate (EVA), polyurethane (PU), acrylates, or mixtures or copolymers or derivatives thereof and plasticizer, preferably polyvinyl butyral (PVB) and plasticizer. In the embodiments in which the acoustically damping layer is colored with a dye, the acoustically damping layer additionally contains a dye.

In one embodiment, the multilayer colored intermediate layer additionally includes a third thermoplastic layer that is colorless and has a wedge-shaped cross-section, wherein the second thermoplastic layer is arranged between the first thermoplastic layer and the third thermoplastic layer.

The invention thus also relates to a multilayer colored thermoplastic intermediate layer at least comprising, in this order, a colorless first thermoplastic layer having a wedge-shaped cross-section, a dye-colored second thermoplastic layer having a substantially constant thickness, and a colorless third thermoplastic layer with a wedge-shaped cross-section.

The colorless third thermoplastic layer preferably has a wedge angle in the range from 0.05 mrad to 0.5 mrad, particularly preferably 0.15 mrad to 0.3 mrad, for example, 0.25 mrad.

It goes without saying that in this embodiment, in which the multilayer colored intermediate layer additionally has a third thermoplastic layer with a wedge-shaped cross-section, the layers with a wedge-shaped cross-section are arranged such that, in each case, the thinner ends are positioned one above another and, in each case, the thicker ends are positioned one above another, i.e., the increase in thickness of the two layers runs in the same direction.

The third thermoplastic layer can contain at least polyvinyl butyral (PVB), ethylene vinyl acetate (EVA), polyurethane (PU), or mixtures or copolymers or derivatives thereof, preferably polyvinyl butyral (PVB), particularly preferably polyvinyl butyral (PVB) and plasticizer.

In this embodiment, the second thermoplastic layer is preferably implemented as a layer having acoustically damping properties. A second thermoplastic layer implemented as a layer having acoustically damping properties preferably has a thickness of less than 300 μm.

A second thermoplastic layer implemented as a layer having acoustically damping properties can contain at least polyvinyl butyral (PVB), ethylene vinyl acetate (EVA), polyurethane (PU), acrylates, or mixtures or copolymers or derivatives thereof and plasticizer, preferably polyvinyl butyral (PVB) and plasticizer.

In the multilayer thermoplastic intermediate layer according to the invention, the light transmittance through the multilayer colored thermoplastic intermediate layer is constant over its entire area.

In a particularly preferred embodiment of the multilayer thermoplastic intermediate layer according to the invention, the color of the multilayer colored thermoplastic intermediate layer is substantially constant over its entire area.

Color differences are usually calculated in the CIELab color model as the Euclidean distance of the L*a*b* values of two colors measured at different measuring points.

In the context of this application, a substantially constant color means that the color distance as required by the automotive industry, i.e., the Euclidean distance ΔE′ taking into account the sensitivity of the eye is less than 0.5, preferably less than 0.2.

$$Δ {E}^{′} = \sqrt{{( \frac{Δ {L}^{*}}{2} )}^{2} + {( Δ {a}^{*} )}^{2} + {( Δ {b}^{*} )}^{2}}$$

Where

ΔL*=L₁*−L₂*

Δa*=a₁*−a₂*

Δb*=b₁*−b₂*

L₁*=luminance at a first position

L₂*=luminance at a second position

a₁*=value for the green or red component of a color at a first position

a₂*=value for the green or red component of a color at a second position

b₁*=value for the blue or yellow component of a color at a first position

b₂*=value for the blue or yellow component of a color at a second position

ΔE′=Euclidean distance of the L*a*b* values of two colors taking into account the sensitivity of the eye

For example, the values can be L*=85, a*=−0.5, and b*=−0.5.

The multilayer colored thermoplastic intermediate layer can optionally additionally have a colored band of different color intensity, a so-called shaded band as described, for example, in U.S. Pat. No. 4,562,023. It goes without saying that in the region of such an additional colored band, the light transmittance and the color are not constant.

The invention also relates to a composite pane, at least comprising a first pane and a second pane that are joined to one another via the multilayer colored thermoplastic intermediate layer according to the invention.

The multilayer colored thermoplastic intermediate layer according to the invention has, as described above, a wedge-shaped cross-section and can be formed as in the various embodiments described above.

The composite pane according to the invention has an upper edge and a lower edge. “Upper edge” refers to that side edge of the composite pane that is intended to point upward in the installed position. “Lower edge” refers to that side edge that is intended to point downward in the installed position. If the composite pane is the windshield of a motor vehicle, the upper edge is often also referred to as the “roof edge”; and the lower edge, as the “engine edge”.

The first pane and the second pane have in each case an exterior-side surface and an interior-side surface and a circumferential side edge running therebetween. In the context of the invention, “exterior-side surface” refers to that primary surface that is intended, in the installed position, to face the external environment. In the context of the invention, “interior-side surface” refers to that primary surface that is intended, in the installed position, to face the interior. The interior-side surface of the pane that is the outer pane and the exterior-side surface of the pane that is the inner pane face each other and are joined to one another by the multilayer colored thermoplastic intermediate layer according to the invention.

In one embodiment, the first pane is an outer pane and the second pane is an inner pane. In an alternative embodiment, the first pane is an inner pane; and the second pane, an outer pane.

In the case of a vehicle pane, “inner pane” refers to that pane which is intended to face the interior of the vehicle in the installed position. “Outer pane” refers to that pane which is intended to face the external environment of the vehicle in the installed position.

The first pane and the second pane have a substantially constant cross-section.

However, it is also possible for the first pane and/or the second pane to have a wedge-shaped cross-section. The wedge angle of such a pane with a wedge-shaped cross-section is preferably 0.05 mrad to 0.5 mrad, particularly preferably 0.15 mrad to 0.3 mrad, for example, 0.25 mrad.

In the present application, a “substantially constant cross-section of a pane” means that the thickness of the pane is constant over the length and width within normal manufacturing tolerances. Preferably, this means that the thickness varies by no more than 7%, preferably by no more than 5%, particularly preferably by no more than 3%.

Since the composite pane according to the invention includes a multilayer colored thermoplastic intermediate layer according to the invention with a wedge-shaped cross-section and two panes having a substantially constant thickness or with a wedge-shaped cross-section, the composite pane according to the invention has a wedge-shaped cross-section.

It goes without saying that “cross-section” means the cross-section in vertical progression between the lower edge and the upper edge. In the composite panes according to the invention, the thickness increases from the lower edge to the upper edge. The thicker first end is thus situated at the upper edge and the thinner second end at the lower edge of the composite pane. This applies equally to the multilayer colored thermoplastic intermediate layer according to the invention and the wedge-shaped layer or wedge-shaped layers that the multilayer colored thermoplastic intermediate layer according to the invention has, as described above in the various embodiments.

In vehicle construction, the thickness is typically varied such that the smallest thickness is provided at the lower end of the composite glass pane toward the engine compartment with the thickness increasing toward the roof.

The wedge angle of the composite pane according to the invention is preferably 0.1 mrad to 1.0 mrad, particularly preferably 0.3 mrad to 0.6 mrad, for example, 0.5 mrad.

The composite pane according to the invention can include one or more additional intermediate layers, in particular functional intermediate layers, with these additional intermediate layers being of substantially constant thickness. In other words, the one or more additional intermediate layers have no wedge angle.

This at least one additional intermediate layer is arranged between the first pane and the multilayer colored thermoplastic intermediate layer or between the second pane and the multilayer colored thermoplastic intermediate layer. If the composite pane according to the invention has two or more additional intermediate layers, it is also possible for at least one of the additional intermediate layers to be arranged between the first pane and the multilayer colored thermoplastic intermediate layer and for at least one of the additional intermediate layer to be arranged between the second pane and the multilayer colored thermoplastic intermediate layer.

An additional intermediate layer can be, in particular, an infrared radiation-reflecting element, an ultraviolet-radiation-absorbing layer, a barrier layer, or a combination of these. In the event of the presence of a plurality of additional intermediate layers, these can also have different functions.

The additional intermediate layer can also be implemented as a functional intermediate layer with acoustically damping properties. It goes without saying that the additional intermediate layer is preferably implemented as a functional intermediate layer with acoustically damping properties when the multilayer colored thermoplastic intermediate layer does not already comprise a layer with acoustically damping properties.

The first pane and the second pane are preferably made of glass, particularly preferably of soda lime glass, as is customary for window panes. However, the panes can also be made of other types of glass, for example, quartz glass, borosilicate glass, or aluminosilicate glass, or of rigid clear plastics, for example, polycarbonate or polymethyl methacrylate.

The first pane and/or the second pane can have antireflection coatings, non-stick coatings, anti-scratch coatings, photocatalytic coatings, electrically heatable coatings, solar protection coatings, and/or low-E coatings.

The thickness of the first pane and the second pane can vary widely and thus be adapted to the requirements in the individual case. The first pane and the second pane preferably have thicknesses of 1 mm to 5 mm, particularly preferably of 1 mm to 3 mm. For example, that pane that is the outer pane in the installed position is 2.1 mm thick, and that pane that is the inner pane in the installed position is 1.6 mm thick. However, the first pane or the second pane, in particular that pane that is the inner pane, can also be thin glass with a thickness of, for example, 0.55 mm.

As described above, the first pane and/or the second pane can also have a wedge-shaped cross-section. In this case, the thickness is preferably 1 mm to 5 mm at the thinner end.

The height of the first pane and the second pane, in other words, in the case of a windshield, the distance between the roof edge of the composite pane and the engine edge of the composite pane is preferably between 0.8 m and 1.40 m, particularly preferably between 0.9 m and 1.25 m, for example, 1.0 m. It goes without saying that the height of the multilayer colored thermoplastic intermediate layer and the optional additional intermediate layers is thus also preferably between 0.8 m and 1.40 m, particularly preferably between 0.9 m and 1.25 m, for example, 1.0 m.

The composite pane according to the invention can be a vehicle pane. A vehicle pane is intended for separating a vehicle interior from an external environment. A vehicle pane is thus a window pane that is or is intended to be inserted into a window opening of the vehicle body. A composite pane according to the invention is, in particular, a windshield of a motor vehicle.

The first pane and the second pane can be, independently of one another, clear and colorless, but also tinted, frosted, or colored. The total transmittance through the composite pane is, in a preferred embodiment, greater than 70%, in particular when the composite pane is a windshield. The term “total transmittance” is based on the process for testing the light permeability of motor vehicle windows specified by ECE-R 43, Annex 3, § 9.1. The first pane and the second pane can be made, for example, of non-tempered, partially tempered, or tempered glass.

In the case of composite panes intended as windshields, the coloring or tinting is such that the composite pane has light transmittance greater than 70% in the spectral range from 380 nm to 780 nm. In the case of composite panes intended as roof panels or rear side windows, the coloring or tinting can also be darker, and the composite panes can thus have light transmittance of 70% or less in the spectral range from 380 nm to 780 nm.

A composite pane according to the invention can, additionally, include a masking print, made in particular from a dark, preferably black, enamel. The masking print is, in particular, a peripheral, i.e., frame-like, masking print. The peripheral masking print serves primarily as UV protection for the mounting adhesive of the composite pane. The masking print can be opaque and cover the entire surface. The masking print can also be designed, at least in sections, semitransparent, for example, as a point grid, strip grid, or checkered grid. Alternatively, the masking print can also have a gradient, for example, from an opaque covering to a semitransparent covering. The masking print is customarily applied on the interior-side surface of that pane that is the outer pane in the installed position or on the interior-side surface of that pane that is the inner pane in the installed position.

The composite pane according to the invention is preferably curved in one or a plurality of spatial directions, as is customary for motor vehicle windows, with typical radii of curvature in the range from approx. 10 cm to approx. 40 m. The composite glass can, however, also be flat, for example, when it is provided as a pane for buses, trains, or tractors.

The composite pane according to the invention can be used, for example, as a head-up display (HUD) for displaying information.

The invention also relates to a projection arrangement for a head-up display (HUD) at least comprising a composite pane according to the invention and a projector. As usual with HUDs, the projector illuminates a region of the windshield where the light is reflected in the direction of the viewer (driver), creating a virtual image that the viewer perceives as behind the windshield from his point of view. The region of the windshield that can be illuminated by the projector is referred to as the “HUD region”. The direction of illumination of the projector can typically be varied by mirrors, in particular vertically, in order to adapt the projection to the body size of the viewer. The region in which the eyes of the viewer must be situated with a given mirror position is referred to as the “eye box window”. This eye box window can be shifted vertically by adjustment of the mirrors, with the entire area thus available (i.e., the overlay of all possible eye box windows) referred to as the “eye box”. A viewer situated within the eye box can perceive the virtual image. This, of course, means that the eyes of the viewer must be situated within the eye box not, for example, the entire body.

The technical terms from the field of HUDs used here are generally known to the person skilled in the art. For a detailed presentation, reference is made to the dissertation “Simulation-Based Metrology for Testing Head-Up Displays” by Alexander Neumann at the Informatics Institute of Munich Technical University (Munich: University Library of Munich TU, 2012), in particular to chapter 2 “The Head-Up Display”.

The above-described preferred embodiments of the multilayer colored thermoplastic intermediate layer according to the invention and/or the composite pane according to the invention also apply mutatis mutandis to the projection arrangement comprising a composite pane according to the invention and a projector.

The invention also relates to a method for producing a multilayer colored thermoplastic intermediate layer, wherein the method has at least the step of co-extrusion of at least one colorless first thermoplastic layer with a wedge-shaped cross-section and a dye-colored second thermoplastic layer with substantially constant thickness.

The extrusion is usually carried out at temperatures between 150° C. and 200° C.

In one embodiment of the method, the method includes the step of co-extrusion of a colorless first thermoplastic layer with a wedge-shaped cross-section and a dye-colored second thermoplastic layer having a substantially constant thickness. Two extruders are required for this embodiment of the method: one for the colorless first thermoplastic layer and one for the dye-colored second thermoplastic layer. The two extruders are connected to a two-slot die.

In another embodiment of the method, the method includes the step of the co-extrusion of a colorless first thermoplastic layer with a wedge-shaped cross-section, a dye-colored second thermoplastic layer having a substantially constant thickness, and a colorless third thermoplastic layer with a wedge-shaped cross-section, wherein the layers are extruded such that the dye-colored second thermoplastic layer is arranged between the colorless first thermoplastic layer and the colorless third thermoplastic layer. Two extruders are required for this embodiment of the method: one extruder for the two outer layers, i.e., the colorless first thermoplastic layer and the colorless third thermoplastic layer, and one extruder for the dye-colored second thermoplastic layer. The two extruders are connected to a three-slot die.

In another embodiment of the method, the method includes the step of the co-extrusion of a colorless first thermoplastic layer with a wedge-shaped cross-section, an acoustically damping layer having a substantially constant thickness, and a dye-colored second thermoplastic layer having a substantially constant thickness, wherein the layers are extruded such that the acoustically damping layer is arranged between the first thermoplastic layer and the second thermoplastic layer. Three extruders are required for this embodiment of the method: one extruder for the colorless first thermoplastic layer, one extruder for the acoustically damping layer, and one extruder for the dye-colored second thermoplastic layer. The three extruders are connected to a three-slot die. In one embodiment of this method, the acoustically damping layer is colorless; in an alternative embodiment, the acoustically damping layer is colored with a dye. In the embodiment in which the acoustically damping layer is colored with a dye, the dye and its concentration in the dye-colored acoustically damping layer and the dye and its concentration in the dye-colored second thermoplastic layer must, in particular, be selected such that the resulting color and the light transmittance of the multilayer colored thermoplastic intermediate layer meets the respective desired requirements.

The invention also relates to a method for producing a multilayer colored thermoplastic intermediate layer, wherein the method comprises at least the following steps:
a) Providing a colorless first thermoplastic layer having a wedge-shaped cross-section
b) Extruding a dye-colored second thermoplastic layer having a substantially constant thickness;
c) Arranging the first thermoplastic layer and the second thermoplastic layer one above another in a planar manner;
d) Joining the first thermoplastic layer and the second thermoplastic layer at least in a circumferential edge region.

The providing of the colorless first thermoplastic layer having a wedge-shaped cross-section in step a) can be done by extrusion of a wedge-shaped layer. Alternatively, it is possible for the colorless first thermoplastic layer with a wedge-shaped cross-section to be provided by extrusion of a colorless thermoplastic layer of constant thickness and subsequent stretching of the layer. Suitable methods for stretching a thermoplastic layer having constant thickness to produce a thermoplastic layer with a wedge-shaped cross-section are known to the person skilled in the art.

The steps a) and b) can also be carried out in reverse order.

The joining of the first thermoplastic layer and the second thermoplastic layer at least in a circumferential edge region can, for example, be carried out by heating to a temperature above 40° C., for example, 80° C., for a period of at least 10 minutes, for example, 20 minutes.

Alternatively, the joining of the first thermoplastic layer and the second thermoplastic layer at least in a circumferential edge region can also be carried out using a chemical, such as, for example, an alcohol, in particular ethanol or isopropanol.

It goes without saying that the joining of the first thermoplastic layer and the second thermoplastic layer can also be carried out over the entire surface.

The joining of the first thermoplastic layer and the second thermoplastic layer can also occur only within the lamination of a composite pane according to the invention comprising a first pane, a second pane, and a multilayer colored thermoplastic intermediate layer according to the invention positioned therebetween. In this case, the joining is carried out over the entire surface.

If the multilayer colored thermoplastic layer comprises more layers than the first thermoplastic layer and the second thermoplastic layer, it goes without saying that, in this embodiment, the method includes, as additional steps, providing the at least one additional layer; in step c) the first thermoplastic layer, the second thermoplastic layer, and the at least one additional layer are arranged one above another in a planar manner in the desired order; and in step d), the layers are then joined to one another at least in a circumferential edge region.

The at least one additional layer can, for example, be implemented as an acoustically damping layer or a third thermoplastic layer.

In a preferred embodiment, the method according to the invention includes, between the steps b) and c), an additional step e), in which indentations are embossed in at least one of the surfaces of the first thermoplastic layer and in at least one of the surfaces of the second thermoplastic layer. By means of the embossed indentations, a surface roughness Rz of 10 μm to 75 μm, preferably of 25 μm to 75 μm, particularly preferably of 35 μm to 65 μm, for example, 50 μm, can be achieved.

Methods for embossing indentations are disclosed, for example, in the publications U.S. Pat. Nos. 5,455,103, 6,863,956 B1, and 7,883,761 B2.

Alternatively, a surface roughness Rz of 15 μm to 45 μm, for example, 30 μm, in the thermoplastic layers can also be achieved by the method of melt fracturing known to the person skilled in the art.

If indentations are embossed on only one of the surfaces of the first thermoplastic layer and on only one of the surfaces of the second thermoplastic layer, in step c), the first thermoplastic layer and the second thermoplastic layer are arranged one above another in a planar manner such that the surfaces in which indentations had been embossed face one another. The embossed indentations improve deaeration at the time the first thermoplastic layer is joined to the second thermoplastic layer and prevent clouding of the multilayer colored thermoplastic intermediate layer according to the invention. Such clouding could occur because of the fact that the light transmittance and the color of a colored layer vary with the thickness of the colored layer. As described above, the embossed indentations improve deaeration and the two layers fuse together better.

If the multilayer colored thermoplastic layer includes more layers than the first thermoplastic layer and the second thermoplastic layer, indentations are preferably also embossed in each case on at least one of the surfaces of the additional layers, which can, for example, be implemented as an acoustically damping layer or a third thermoplastic layer such that, in this case as well, better deaeration is achieved and clouding is thus prevented.

In a particularly preferred embodiment, indentations are embossed in each case in both surfaces of the layers provided for production of the multilayer colored thermoplastic intermediate layer according to the invention.

The invention also relates to a method for producing a colored composite pane for a head-up display (HUD), wherein the composite pane has a first pane, a second pane, and a multilayer colored thermoplastic intermediate layer with a wedge-shaped cross-section arranged between the first pane and the second pane, and wherein in the method at least:
a) a first pane and a second pane are provided;
b) a multilayer colored thermoplastic intermediate layer having a wedge-shaped cross-section is provided;
c) the multilayer colored thermoplastic intermediate layer is arranged in a planar manner between the first pane and the second pane; and
d) the first pane, the multilayer thermoplastic intermediate layer, and the second pane are joined by lamination.

The multilayer colored thermoplastic intermediate layer with a wedge-shaped cross-section can be provided according to one of the above-described methods.

The method can additionally include the steps of providing at least one additional intermediate layer and the arrangement thereof independent of one another between the first pane and the multilayer colored thermoplastic intermediate layer or between the second pane and the multilayer colored thermoplastic intermediate layer. The at least one additional intermediate layer has substantially constant thickness. When an additional intermediate layer is provided, it can thus be arranged between the first pane and the multilayer colored thermoplastic intermediate layer or between the second pane and the multilayer colored thermoplastic intermediate layer. When more than one additional intermediate layer is provided, they can thus be arranged either between the first pane and the multilayer colored thermoplastic intermediate layer or between the second pane and the multilayer colored thermoplastic intermediate layer; or additional intermediate layers can be arranged both between the first pane and the multilayer colored thermoplastic intermediate layer and also between the second pane and the multilayer colored thermoplastic intermediate layer.

The at least one additional intermediate layer is preferably a functional intermediate layer, in particular an IR-reflecting layer, a UV-radiation-absorbing layer, a barrier layer, an intermediate layer with acoustically damping properties, or a combination of these. When there are multiple additional intermediate layers, they can also have different functions.

If the composite pane is to be bent, the first pane and the second pane are preferably subjected to a bending process before lamination. Preferably, the first pane and the second pane are bent congruently together (i.e., at the same time and with the same tool), because the shape of the panes is thus optimally matched for the subsequent lamination. Typical temperatures for glass bending processes are, for example, 500° C. to 700° C.

The above-described preferred embodiments of the composite pane according to the invention also apply mutatis mutandis to methods for producing a composite pane according to the invention.

The invention also relates to the use of a multilayer colored thermoplastic intermediate layer according to the invention in a vehicle pane in means of locomotion for travel on land, in the air, or on water, in particular in motor vehicles, and in particular in a windshield in a motor vehicle.

The invention also relates to the use of a composite pane according to the invention as a vehicle pane in means of locomotion for travel on land, in the air, or on water, in particular in motor vehicles and in particular in a windshield in a motor vehicle.

In the following, the invention is explained in detail with reference to drawings and exemplary embodiments. The drawings are schematic representations and not to scale. The drawings in no way restrict the invention.

They depict:

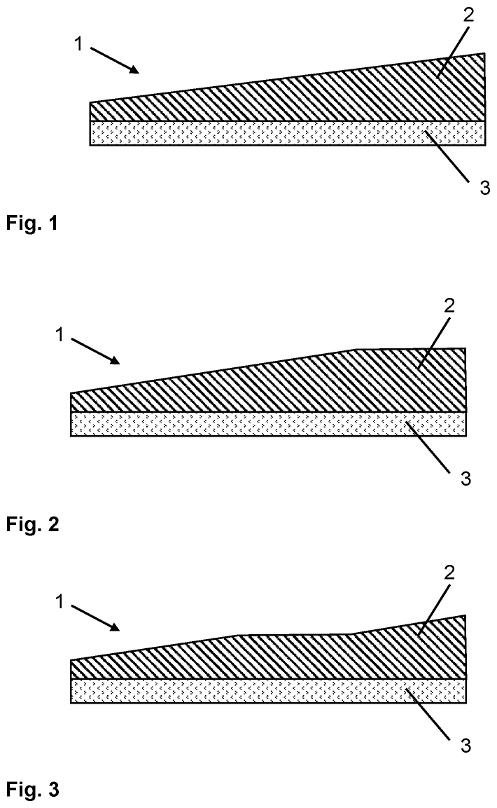

FIG. 1 the cross-section of one embodiment of a multilayer colored thermoplastic intermediate layer according to the invention,

FIG. 2 the cross-section of another embodiment of a multilayer colored thermoplastic intermediate layer according to the invention:

FIG. 3 the cross-section of another embodiment of a multilayer colored thermoplastic intermediate layer according to the invention;

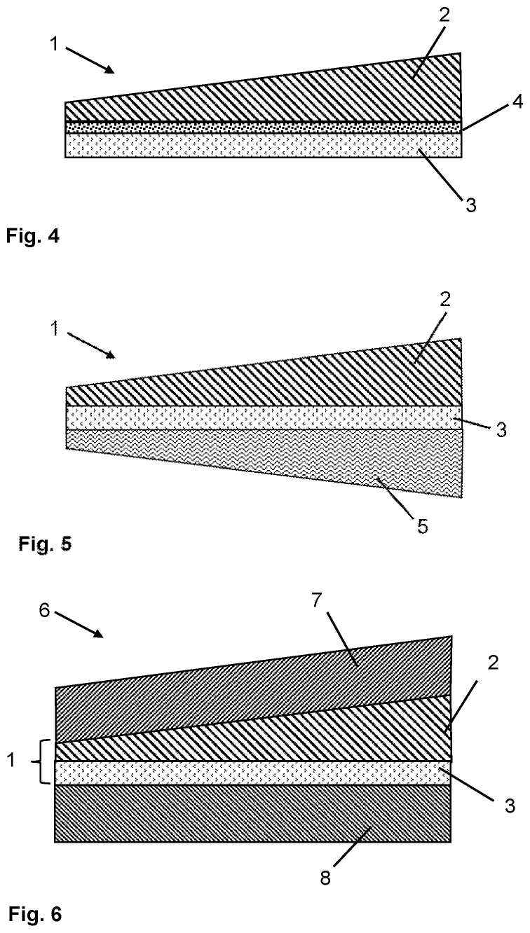

FIG. 4 the cross-section of another embodiment of a multilayer colored thermoplastic intermediate layer according to the invention;

FIG. 5 the cross-section of another embodiment of a multilayer colored thermoplastic intermediate layer according to the invention;

FIG. 6 the cross-section of one embodiment of a composite pane according to the invention;

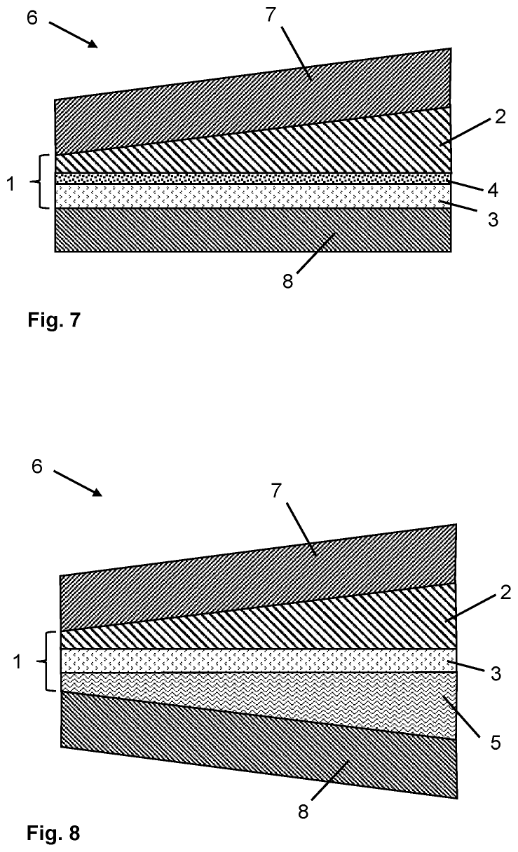

FIG. 7 the cross-section of another embodiment of a composite pane according to the invention;

FIG. 8 the cross-section of another embodiment of a composite pane according to the invention;

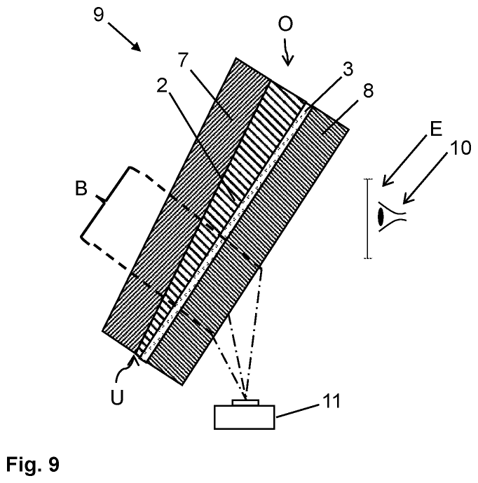

FIG. 9 the cross-section of one embodiment of a projection arrangement according to the invention;

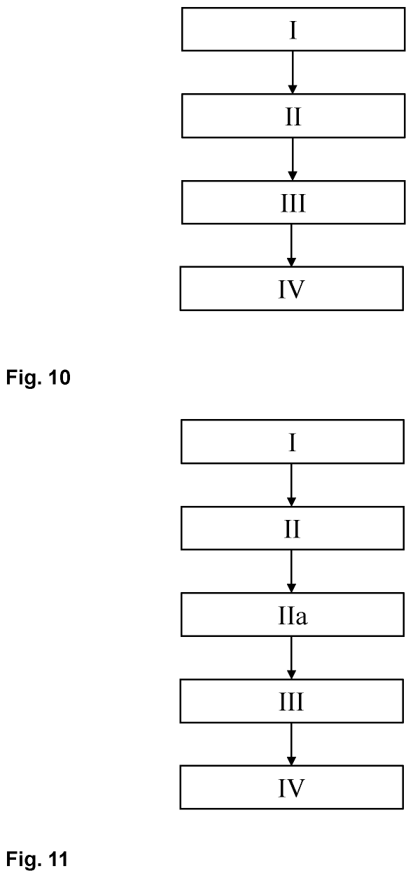

FIG. 10 a flow chart of one embodiment of a method according to the invention;

FIG. 11 a flow chart of another embodiment of a method according to the invention.

FIG. 1 depicts one embodiment of a multilayer colored thermoplastic intermediate layer 1 according to the invention in cross-section. In the embodiment depicted in FIG. 1, the multilayer colored thermoplastic intermediate layer 1 consists of a first thermoplastic layer 2 with a wedge-shaped cross-section and a second thermoplastic layer 3 of constant thickness. The first thermoplastic layer thus has a thicker first end and a thinner second end. The increase in thickness from the second end to the first end of the first thermoplastic layer 2 and thus also the increase in thickness from the second end to the first end of the multilayer colored thermoplastic intermediate layer 1 is continuously linear in the embodiment depicted in FIG. 1. The first thermoplastic layer 2 is colorless and the second thermoplastic layer 3 is colored, for example, with an ink. The second thermoplastic layer 3 is, for example, green colored. However, in principle, any other color is also possible, with typical colors for the automobile market being green, blue, and gray.

In the embodiment depicted in FIG. 1, the first thermoplastic layer 2 and thus also the multilayer colored thermoplastic intermediate layer 1 has a wedge angle of 0.5 mrad.

The first thermoplastic layer 2 is, for example, 0.38 mm thick at its thinner second end, and the second thermoplastic layer 3 is 0.38 mm thick. Consequently, in the embodiment depicted in FIG. 1, the multilayer colored thermoplastic intermediate layer 1 is 0.76 mm thick at its thinner second end.

In the embodiment depicted in FIG. 1, the first thermoplastic layer 2 and the second thermoplastic layer 3 are, for example, made of PVB, with the second thermoplastic layer 3 colored with an ink as described above.

FIG. 2 depicts another embodiment of a multilayer colored thermoplastic intermediate layer 1 according to the invention in cross-section. The embodiment depicted in FIG. 2 differs from that depicted in FIG. 1 only in that the first thermoplastic layer 2 and thus also the multilayer colored thermoplastic intermediate layer 1 has a plateau at the thicker first end in cross-section.

FIG. 3 depicts another embodiment of a multilayer colored thermoplastic intermediate layer 1 according to the invention in cross-section. The embodiment depicted in FIG. 3 differs from that depicted in FIG. 1 only in that in the case of the first thermoplastic layer 2 and thus also in the case of the multilayer colored thermoplastic intermediate layer 1, the wedge angle varies in the progression from the thinner second end to the thicker first end.

FIG. 4 depicts another embodiment of a multilayer colored thermoplastic intermediate layer 1 according to the invention in cross-section. The embodiment depicted in FIG. 4 differs from that depicted in FIG. 1 in that the multilayer colored thermoplastic intermediate layer 1 has, in addition to the first thermoplastic layer 2 and the second thermoplastic layer 3, an acoustically damping layer 4 that is arranged between the first thermoplastic layer 2 and the second thermoplastic layer 3. In the embodiment depicted in FIG. 4, this acoustically damping layer has a constant thickness of 100 μm (microns), is colorless, and contains PVB and plasticizer.

FIG. 5 depicts another embodiment of a multilayer colored thermoplastic intermediate layer 1 according to the invention in cross-section. The embodiment depicted in FIG. 5 differs from that depicted in FIG. 1 in that the multilayer colored thermoplastic intermediate layer 1 has, in addition to the first thermoplastic layer 2 and the second thermoplastic layer 3, a third thermoplastic layer 5 that is colorless and has a wedge-shaped cross-section. In the embodiment depicted in FIG. 5, the second thermoplastic layer 3 is arranged between the first thermoplastic layer 2 and the third thermoplastic layer 5. The wedge angle of the first thermoplastic layer 2 and the wedge angle of the third thermoplastic layer 5 are, in the embodiment depicted in FIG. 5, for example, 0.2 mrad in each case such that the multilayer colored thermoplastic intermediate layer 1 in the embodiment depicted in FIG. 5 has a wedge angle of 0.4 mrad. In the embodiment depicted in FIG. 5, the thickness of the first thermoplastic layer 2 is, for example, 0.33 mm, and the thickness of the third thermoplastic layer 5 is, for example, 0.33 mm, at the thinner end in each case. In the embodiment depicted in FIG. 5, the second thermoplastic layer 3 is, for example, an acoustically damping layer with a thickness of 100 μm, yielding a thickness of the multilayer colored thermoplastic intermediate layer 1 of 0.76 mm at the thinner second end. The first thermoplastic layer 2 and the third thermoplastic layer 5 contain, for example, PVB; and the second thermoplastic layer 3 contains, for example, PVB and plasticizer and a dye.

FIG. 6 depicts the cross-section of one embodiment of a composite pane 6 according to the invention. This comprises a first pane 7 and a second pane 8 joined to one another via a multilayer colored thermoplastic intermediate layer 1. The multilayer colored thermoplastic intermediate layer 1 is constructed as depicted in FIG. 1 and thus includes a first thermoplastic layer 2 and a second thermoplastic layer 3. In the embodiment depicted in FIG. 6, the first pane 7 and the second pane 8 are, for example, made of soda lime glass and have a thickness in each case of 2.1 mm. However, it is also possible for the first pane 7 and the second pane 8 to have different thicknesses. In the embodiment depicted in FIG. 6, the first pane 7 and the second pane 8 have no wedge angle. However, it is also possible for the first pane 7 and/or the second pane 8 to have a wedge angle, i.e., a wedge-shaped cross-section. In the embodiment depicted in FIG. 6, in the installed position, the first pane 7 is the outer pane, and the second pane 8 is the inner pane of the composite pane 6. However, it is also possible for the first pane 7 to be the inner pane and the second pane 8 to be the outer pane.

FIG. 7 depicts the cross-section of another embodiment of a composite pane 6 according to the invention. This differs from the embodiment depicted in FIG. 6 only in that the multilayer colored thermoplastic intermediate layer 1 is constructed as depicted in FIG. 4.

FIG. 8 depicts the cross-section of another embodiment of a composite pane 6 according to the invention. This differs from the embodiment depicted in FIG. 6 only in that the multilayer colored thermoplastic intermediate layer 1 is constructed as depicted in FIG. 5.

FIG. 9 depicts the cross-section of a projection arrangement 9 according to the invention. The projection arrangement 9 comprises a composite pane 6, in particular the windshield of a passenger car, with an upper edge O and a lower edge U and two side edges not shown in FIG. 9. In the projection arrangement 9 depicted in FIG. 9, the composite pane 6 corresponds to the composite pane depicted in FIG. 6. The projection arrangement 9 further comprises a projector 11, which is aimed at a region B of the composite pane 6. In the region B, which is commonly referred to as the HUD region, images can be generated by the projector 11, which are perceived by a viewer 10 (vehicle driver) as virtual images on the side of the composite pane 6 facing away from him, when his eyes are situated within the so-called eye box E.

FIG. 10 depicts a flow chart of one embodiment of a method according to the invention for producing a multilayer colored thermoplastic intermediate layer 1 according to the invention.

The embodiment of a method according to the invention depicted in FIG. 10 comprises, as a first step I, the providing of a colorless first thermoplastic layer 2 with a wedge-shaped cross-section. The providing of the colorless first thermoplastic layer 2 having a wedge-shaped cross-section can be done by extruding a wedge-shaped layer. However, it is also possible for the colorless first thermoplastic layer 2 having a wedge-shaped cross-section to be provided by extruding a colorless thermoplastic layer of constant thickness and subsequent stretching of the layer.

In a second step II, the embodiment of a method according to the invention depicted in FIG. 10 includes providing a dye-colored second thermoplastic layer 3 having a substantially constant thickness by extrusion.

The steps I and II can also be carried out in reverse order.

In a third step III, in the embodiment depicted in FIG. 10 of a method according to the invention, the first thermoplastic layer 2 and the second thermoplastic layer 3 are arranged one above another in a planar manner.

In a fourth step IV, the embodiment depicted in FIG. 10 of a method according to the invention includes joining the first thermoplastic layer 2 and the second thermoplastic layer 3, at least in an edge region. The joining of the first thermoplastic layer 2 and the second thermoplastic layer 3 at least in an edge region can, for example, be carried out by heating to a temperature above 40° C., for example, 80° C., or by means of a chemical, such as an alcohol, in particular ethanol or isopropanol.

FIG. 11 depicts a flow chart of another embodiment of a method according to the invention for producing a multilayer colored thermoplastic intermediate layer 1 according to the invention.

The embodiment depicted in FIG. 11 of a method according to the invention differs from that depicted in FIG. 10 only in that it has the additional step IIa. In step IIa, indentations are embossed in at least one of the surfaces of the first thermoplastic layer 2 and in at least one of the surfaces of the second thermoplastic layer 3. If indentations are in each case embossed in only one surface of the first thermoplastic layer 2 and the second thermoplastic layer 3, the first thermoplastic layer 2 and the second thermoplastic layer 3 are preferably arranged, in step III, one above another in a planar manner such that the embossed surfaces are arranged directly adjacent one another. The embossed indentations improve deaeration in step IV and prevent clouding of the multilayer colored thermoplastic intermediate layer 1.

### LIST OF REFERENCE CHARACTERS

1 multilayer colored thermoplastic intermediate layer
2 first thermoplastic layer
3 second thermoplastic layer
4 acoustically damping layer
5 third thermoplastic layer
6 composite pane
7 first pane
8 second pane
9 projection arrangement
10 viewer, vehicle driver
11 projector
B HUD region of the composite pane 6
E eye box, eye box window
O upper pane edge/upper edge/roof edge of the composite pane
U lower pane edge/lower edge/engine edge of the composite pane

1. A multilayer colored thermoplastic intermediate layer, comprising:
a first thermoplastic layer with a wedge-shaped cross-section; and
a second thermoplastic layer having a substantially constant thickness, wherein the first thermoplastic layer is colorless and the second thermoplastic layer is colored with a dye.

2. The multilayer colored thermoplastic intermediate layer according to claim 1, wherein the light transmittance through the multilayer colored thermoplastic intermediate layer is constant over its entire area.

3. The multilayer colored thermoplastic intermediate layer according to claim 1, wherein the multilayer colored thermoplastic intermediate layer has a wedge angle in the range from 0.1 mrad to 1.0 mrad.

4. The multilayer colored thermoplastic intermediate layer according to claim 1, wherein the first thermoplastic layer contains at least polyvinyl butyral (PVB), or ethylene vinyl acetate (EVA), or polyurethane (PU), or mixtures or copolymers or derivatives thereof, and the second thermoplastic layer contains a dye and at least polyvinyl butyral (PVB), or ethylene vinyl acetate (EVA), or polyurethane (PU), or mixtures or copolymers or derivatives thereof.

5. The multilayer colored thermoplastic intermediate layer according to claim 1, additionally including an acoustically damping layer having a substantially constant thickness, wherein the acoustically damping layer is arranged between the first thermoplastic layer and the second thermoplastic layer and is colorless or colored with a dye.

6. The multilayer colored thermoplastic intermediate layer according to claim 1, additionally including a third thermoplastic layer that is colorless and has a wedge-shaped cross-section, wherein the second thermoplastic layer is arranged between the first thermoplastic layer and the third thermoplastic layer.

7. The multilayer colored thermoplastic intermediate layer according to claim 6, wherein the second thermoplastic layer is a layer having acoustically damping properties.

8. A composite pane, at least comprising a first pane, a second pane, and a multilayer colored thermoplastic intermediate layer according to claim 1 arranged between the first pane and the second pane.

9. The composite pane according to claim 8, additionally comprising at least one additional intermediate layer that is arranged between the first pane and the multilayer colored thermoplastic intermediate layer or between the second pane and the multilayer colored thermoplastic intermediate layer and has a substantially constant thickness.

10. The composite pane according to claim 8, wherein the composite pane is a vehicle pane.

11. A projection arrangement for a head-up display for displaying information for a viewer in an HUD region, comprising:
a composite pane according to claim 8, and
a projector aimed at the HUD region.

12. A method for producing a multilayer colored thermoplastic intermediate layer according to claim 1, comprising:
co-extrusion of at least one colorless first thermoplastic layer with a wedge-shaped cross-section and a dye-colored second thermoplastic layer with substantially constant thickness.

13. A method for producing a multilayer colored thermoplastic intermediate layer according to claim 1, comprising:
providing a colorless first thermoplastic layer having a wedge-shaped cross-section;
extruding a dye-colored second thermoplastic layer having a substantially constant thickness;
arranging the colorless first thermoplastic layer and the dye-colored second thermoplastic layer one above the other in a planar manner;
joining the colorless first thermoplastic layer and the dye-colored second thermoplastic layer at least in a circumferential edge region.

14. The method according to claim 13, additionally comprising embossing indentations in at least one of surfaces of the colorless first thermoplastic layer and in at least one of surfaces of the dye-colored second thermoplastic layer.

15. A method comprising providing a multilayer colored thermoplastic intermediate layer according to claim 1 in a vehicle pane in a vehicle of locomotion for travel on land, in the air, or on water.

16. The multilayer colored thermoplastic intermediate layer according to claim 3, wherein the wedge angle is in the range from 0.3 mrad to 0.6 mrad.

17. The multilayer colored thermoplastic intermediate layer according to claim 4, wherein the first thermoplastic layer contains polyvinyl butyral (PVB) and plasticizer, and the second thermoplastic layer contains a dye and polyvinyl butyral (PVB) and plasticizer.

18. The composite pane according to claim 9, wherein the at least one additional intermediate layer is an infrared-radiation-absorbing layer, an infrared-radiation-reflecting layer, a UV-radiation-absorbing layer, a barrier layer, an intermediate layer having acoustically damping properties, or a combination of these.

19. The composite pane according to claim 10, wherein the vehicle pane is a windshield for a motor vehicle.

20. The method according to claim 15, wherein the vehicle pane is a windshield that is used as a projection surface of a projection arrangement for a head-up display.
